(19) United States
(12) Patent Application Publication
(10) Pub. No.: US 2016/0101308 A1
(43) Pub. Date: Apr. 14, 2016

(54) Drug Disposal System

(71) Applicant: BOARD OF REGENTS, THE UNIVERSITY OF TEXAS SYSTEM, Austin, TX (US)

(72) Inventors: Kevin Albert Schug, Southlake, TX (US); Nour Moussa Hussein, Maumelle, AR (US); Shadi Rajai Zumut, Keller, TX (US)

(73) Assignee: Board of Regents, The University of Texas System, Austin, TX (US)

(21) Appl. No.: 14/889,628

(22) PCT Filed: May 7, 2014
(86) PCT No.: PCT/US14/37096

§ 371 Date: Nov. 6, 2015

Related U.S. Application Data
(60) Provisional application No. 61/820,255, filed on May 7, 2013.

(51) Int. Cl. A62D 3/33

(52) U.S. Cl. CPC A62D 3/33; A62D 2101/20

(57) ABSTRACT

The present invention comprises a safe and effective system for removal of a range of common pharmaceutical compounds. The formulation comprises activated carbon, accompanied by some larger pebble-like material to help break up capsules and tablets upon shaking, in the presence of an acidified liquid medium. Drugs are added to the bottle and the bottle is shaken so that the drugs are dissolved by the liquid solution and are irreversibly adsorbed onto activated carbon, thereby sequestering them from further use.

### BACKGROUND OF THE INVENTION

The invention relates to disposal of chemicals. More specifically the invention relates to safe and effective systems for home, office, hospital, clinic, or governmental disposal of drugs, such as prescription drugs.

The proper disposal of expired and otherwise unused drug compounds is an important issue for both personal health and environmental reasons. There is a clear need for reliable systems which can be used by individual consumers, pharmacies, other health care providers, and governments in order to insure that unused pharmaceuticals are not available for consumption, either abusive or otherwise, or released into the environment due to improper disposal.

### SUMMARY OF THE INVENTION

The present invention comprises a safe and effective system for removal of a range of common pharmaceutical compounds. These compounds possess a range of physicochemical properties (size, solubility, chemical functional units, etc.), and are found in both prescribed and over-the-counter medications.

The formulation comprises activated carbon, accompanied by some larger pebble-like material to help break up capsules and tablets upon shaking, in the presence of an acidified liquid medium.

Drugs are added to the bottle and the bottle is shaken so that the drugs are dissolved by the liquid solution. Active ingredients are irreversibly adsorbed onto activated carbon, thereby sequestering them from further use.

A variety of drug compounds, representing a range of formulations and chemical structures can be effectively inactivated using the system.

### BRIEF DESCRIPTION OF THE DRAWING

FIG. 1 is a drawing of an embodiment of the invention.

### DETAILED DESCRIPTION OF THE INVENTION

The system comprises a formulation of activated carbon, an acidic solution, and a mechanical dissolution aid delivered in a bottle. The drug is added to the bottle and the bottle is shaken whereupon the drug is dissolved and adsorbed by the activated carbon. The bottle can then be disposed.

The acidic solution is a mixture of formic acid and methanol. The formic acid is used as a 15% aqueous solution (15 ml of pure acid per 100 ml of water). The solution includes about 80% formic acid dilution and about 20% methanol. The amounts of formic acid and methanol can vary up to 20%.

Activated carbon is included in an amount of about 25 g per 100 ml of solution. The amount of carbon can vary from about 20 to 35 gr/100 ml. The activated carbon can have a variety of mesh sizes and can be powdered activated carbon (PAC) or granulated activated carbon (GAC). It can have a surface area ranging from about 500 m²/g and up to about 1750 m²/g. Examples of activated carbon include GAC 8/20, GAC 12/40, GAC 8/30, K-BG, S-51, Norit SX-4 (PAC), and Norit SX-Ultra (PAC).

The mechanical dissolution aid can be a plurality of pebbles. The pebbles are desirably approximately 0.2-0.7 cm in diameter and irregularly shaped. The amount of pebbles added to the formula can range from one to four times the amount of the activated carbon used. The mechanical dissolution aid prevents clumping of the activated carbon in the sample slurry; it also increases dispersion of the activated carbon in the solution upon shaking.

The solution, activated carbon, and mechanical dissolution aids are placed in a container such as a plastic bottle. Any size bottle can be used. A convenient option is an 8 oz. plastic bottle, which desirably will contain about 4-6 oz. solution, 20 to 50 g of activated carbon, and 40 to 150 g of pebbles.

In another embodiment the container is a one gallon container containing similar ingredients in similar proportions. Other containers can be used so long as they do not interfere with the ingredients and can preferably be disposed of after use. The bottle is provided to the end user having the solution, activated carbon, and mechanical dissolution aid therein. After use, the bottle can desirably be securely sealed and disposed. Preferably the bottle is sealed with a child proof top, or another type of seal which cannot be easily reopened.

The bottle is desirably supplied to the end user having an amount of the formulation inside. Preferably the bottle is about 50% filed with the formulation but it can be more or less filled, generally between about 50% and 90%. The user obtains a system having the capacity needed. Desirably, systems are provided having a capacity of from about 2.25 g (in an 8 oz. bottle) to about 3 kg (in a 55 gal. drum) of active drug ingredient (not including inactive ingredients). The bottle drug capacity was determined as a conservative estimate based on trials where increasing doses of acetaminophen were added to a given amount of activated carbon, in order to determine the threshold of non-sequestration. The threshold is likely realistically about 1.5 to 2 times this value.

The drug or drugs are added to the bottle which is then shaken for two minutes and allowed to stand for about one hour. The chemicals contained within the drug product are dissolved by the liquid and irreversibly adsorbed onto the activated carbon, thus rendering them sequestered and inactive.

Any type of drug product can be disposed of using the system, including capsules, tablets, patches, powders, etc., as long as the mass of the active ingredient specified for the given bottle size is not significantly exceeded.

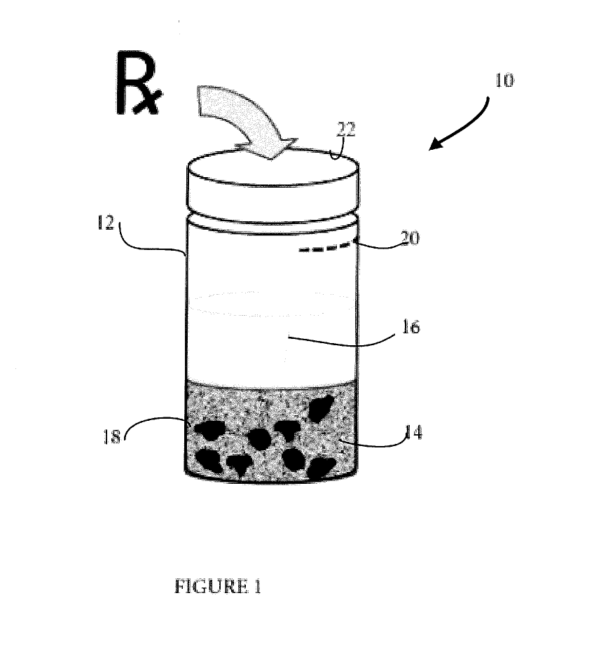

FIG. 1 illustrates an exemplary embodiment of the system 10. Bottle 12 contains fine-grade activated charcoal 14, an acidic solution 16, and pebbles 18. A fill line 20 is indicated on the bottle 12 and the bottle 12 is closed with a cap 22.

The examples below serve to further illustrate the invention, to provide those of ordinary skill in the art with a complete disclosure and description of how the compounds, compositions, articles, devices, and/or methods claimed herein are made and evaluated, and are not intended to limit the scope of the invention. In the examples, unless expressly stated otherwise, amounts and percentages are by weight, temperature is in degrees Celsius or is at ambient temperature, and pressure is at or near atmospheric.

### Example 1

The effectiveness of the system for removal of a range of common pharmaceutical compounds was tested. The system included an 8 oz. plastic bottle, formic acid solution, activated carbon, and pebbles.

100 g of aquarium pebbles were added to the 8 oz. polypropylene bottle. Black pebbles brand Aqua Culture Aquarium Gravel were used.

125 mL of a formic acid/methanol solution was added to the bottle, prepared as follows. Formic acid (from JT Baker) can usually be purchased at a concentration of 85-88% in water and is diluted with water until it is 15% concentration (i.e., if the formic acid is 85%, then mix 3 parts of 85% formic acid with 17 parts water). The 15% formic acid was then mixed with methanol to create the formula solution (mix 4 parts of 15% formic acid with 1 part methanol). The methanol was ACS grade, purchased from Fisher Scientific.

37.5 g of powdered activated carbon was added to the bottle. The powdered activated carbon was Norit SX-4 (also called Norit SX-Ultra), purchased from Sigma-Aldrich.

The bottle was capped tightly and shaken well to mix. Following shaking, the bottle was let stand for 30 minutes capped loosely. Some outgassing may be observed.

The compounds tested, shown in Table 1, possess a range of physicochemical properties (size, solubility, chemical functional units, etc.) and are found in both prescribed and over-the-counter medications. As can be seen in Table 1, a combination of 45 pills of 8 different types, which contain different levels of active ingredients, was chosen to approach the limit of active ingredients indicated on the bottle (2250 mg active ingredient in the 8 oz. bottle).

Three separate trials were performed. In each trial, the mixture of pills was introduced into the bottle, shaken well by hand for approximately two minutes, and then allowed to sit for an hour. A sample was taken at one hour and analyzed by high performance liquid chromatography-mass spectrometry (HPLC-MS). The peak area for each drug compound of interest was monitored and compared to that obtained from an equivalent aliquot of drug compound dissolved directly in solution. The analysis was performed on a Shimadzu LCMS-2020 single quadrupole electrospray ionization-mass spectrometry, operated in the positive ionization mode. A standard mobile phase gradient on a C18 column (Phenomenex) was used to perform the liquid chromatographic separation in the reversed phase. Appropriate dilutions of the standard solutions and the product solutions were made to ensure that all monitored signals were on scale.

TABLE 1

| | | | Total | Total | Active |
|---|---|---|---|---|---|
| | | | Active | Mass of | Ingredient |
| | Active | Number | Ingredient | Pills Per | Removed |
| | Ingredient | Pills Per | Per Trial | Trial | After |
| Medication | (mg/pill) | Trial | (mg) | (mg) | 1 Hour |
| Buspirone | 30 | 6 | 180 | 2416 | 98.9% |
| Diphenhydramine | 25 | 5 | 125 | 1252 | 97.3% |
| Duloxetine | 30 | 8 | 240 | 1700 | >99.9% |
| Fluoxetine | 10 | 6 | 60 | 1640 | 99.5% |
| Metoprolol | 50 | 3 | 150 | 647 | 97.0% |
| tartrate | | | | | |
| Paracetamol | 500 | 1 | 500 | 598 | 99.0% |
| Simvastatin | 20 | 12 | 240 | 2450 | >99.9% |
| Valsartan | 80 | 4 | 320 | 641 | >99.9% |
| TOTAL or | 93 | 45 | 1815 | 11344 | 99.0% |
| AVERAGE | (average) | (total) | (total) | (total) | (average) |

The product removed virtually all active ingredients from detection. The maximum active ingredient specified (2250 mg/8 oz. bottle) was not exceeded.

### Example 2

The same system as in Example 1 was used, with the exception that K-BG activated charcoal was used. Various amounts of acetaminophen were used to test the system. The results are shown in Table 2.

TABLE 2
K-BG* Charcoal, Surface Area = 1700 m²/g

| ACETO (mg) | Intensity of K-BG | Free Aceto | Adsorbed | Adsorbed |
|---|---|---|---|---|
| in 125 mL | (1 uL-Injection) | (mg) | (mg) | (%) |
| 2000 | 253444 | 36.66 | 1963.34 | 98.17 |
| 2500 | 672459 | 60.34 | 2439.66 | 97.59 |
| 3000 | 1157411 | 87.74 | 2912.26 | 97.08 |
| 3500 | 1660554 | 116.17 | 3383.83 | 96.68 |
| 4000 | 2372938 | 156.42 | 3843.58 | 96.09 |
| 4500 | 2842043 | 182.93 | 4317.07 | 95.93 |

*For the 2000 mg sample, only 35 g out of the 37.5 g of K-BG Charcoal was added.

### Example 3

The same system as in Example 1 was used, with the exception that S-51 activated charcoal was used. Various amounts of acetaminophen were used to test the system. The results are shown in Table 2.

TABLE 3
S-51 Charcoal, Surfaced Area = 650 m²/g

| ACETO (mg) | Intensity of S-51 | Free Aceto | Adsorbed | Adsorbed |
|---|---|---|---|---|
| in 125 mL | (1 uL-Injection) | (mg) | (mg) | (%) |
| 2000 | 109408 | 28.53 | 1971.47 | 98.57 |
| 2500 | 410492 | 45.54 | 2454.46 | 98.18 |
| 3000 | 1168471 | 88.37 | 2911.63 | 97.05 |
| 3500 | 1770414 | 122.38 | 3377.62 | 96.50 |
| 4000 | 2856454 | 183.74 | 3816.26 | 95.41 |
| 4500 | 7503896 | 446.34 | 4053.66 | 90.08 |

### Example 4

An experiment was performed to deter nine the break-through amount of adsorption capacity for a gallon-size system. The components of the system of example 1 were used in the following amounts with a 1 gallon plastic container: activated carbon 450 g, aquarium rocks 1000 g, formic acid (85%) 165 ml, water 960 ml, methanol 225 ml. Acetaminophen was used to test the absorption capacity of the system.

Acetaminophen tablets were added to reach the indicated amounts of active ingredient shown in Table 2. The bottle was then shaken and let sit for an hour (on average), and then the solution was sampled, filtered, and analyzed for the presence of acetaminophen by liquid chromatography-mass spectrometry.

What became apparent is that proportionally, the gallon formula could hold a lot more than anticipated.

As shown in Table 4, 185 grams worth of acetaminophen was applied to the system with no breakthrough. Greater than 99.99% of it was adsorbed. Extrapolated results indicate that breakthrough appears to be somewhere closer to 626 grams of acetaminophen (preliminarily 90% adsorbed). This is over 1000 acetaminophen pills.

TABLE 4

| | Aceta | | | | |
|---|---|---|---|---|---|
| Aceta | (mg) 1:100 | Intensity | Free | | |
| (mg) | 10 uL- | of (10 uL- | Aceto | Adsorbed | Adsorbed |
| added | Injection | Injection) | (mg) | (mg) | (%) |
| 135000 | 7.50E−03 | 1174072 | 3.69E−03 | 134999.996 | 100.00 |
| 145000 | 8.06E−03 | 1480035 | 4.58E−03 | 144999.995 | 100.00 |
| 155000 | 8.61E−03 | 1480615 | 4.58E−03 | 154999.995 | 100.00 |
| 165000 | 9.17E−03 | 1506134 | 4.66E−03 | 164999.995 | 100.00 |
| 175000 | 9.72E−03 | 1353817 | 4.21E−03 | 174999.996 | 100.00 |
| 185000 | 1.03E−02 | 1568295 | 4.84E−03 | 184999.995 | 100.00 |

Modifications and variations of the present invention will be apparent to those skilled in the art from the forgoing detailed description. All modifications and variations are intended to be encompassed by the following claims. All publications, patents, and patent applications cited herein are hereby incorporated by reference in their entirety.

What is claimed is:

1. A system for disposing of a drug, comprising:
a solution of formic acid and methanol;
activated carbon; and
a mechanical dissolution aid;
wherein the solution, activated carbon, and mechanical dissolution aid are provided in a container.

2. The system of claim 1, wherein the acid solution comprises from about 64 to 96% formic acid (supplied as a 15% aqueous solution) and 4 to 36% methanol.

3. The system of claim 2, wherein the acid solution comprises about 80% formic acid (supplied as a 15% aqueous solution) and 20% methanol.

4. The system of claim 1, wherein the acid solution is used in an amount about 50 to 75% the volume of the container.

5. The system of claim 1, wherein the activated carbon is used in an amount ranging from about 20 to 35 grams per 100 ml solution.

6. The system of claim 5, wherein the activated carbon is used in an amount of about 25 grams per 100 ml acid solution.

7. The system of claim 1, wherein the activated carbon has a surface area ranging from about 500 m²/g to about 1750 m²/g.

8. The system of claim 7, wherein the activated carbon is selected from the group GAC 8/20, GAC 12/40, GAC 8/30, K-BG, S-51, Norit SX-4 (PAC), and Norit SX-Ultra (PAC).

9. The system of claim 1, wherein the container is made from a plastic or other material, chosen based on its ability to contain a certain volume of formula, accommodate a certain amount of active ingredient, its inertness, or its disposability.

10. The system of claim 1, wherein the mechanical dissolution aid is a plurality of pebbles.

11. The system of claim 10, wherein the pebbles are approximately 0.2-0.7 cm in diameter and irregularly shaped.

12. The system of claim 10, wherein the pebbles are added in an amount from about one to four times the amount of the activated carbon used.

13. The system of claim 1, wherein the capacity of the system to adsorb drug is at least about 2.25 g for an 8 oz container.

14. The system of claim 1, wherein the chemicals contained within the drug are dissolved by the solution and adsorbed onto the activated carbon, thus rendering them sequestered and inactive.

15. A method for disposing of a drug, comprising:
providing a system comprising a container containing a solution of formic acid and methanol, activated carbon, and a mechanical dissolution aid; and
adding the drug to the container;
so that the chemicals contained within the drug are dissolved by the solution and adsorbed onto the activated carbon, thus rendering them sequestered and inactive.

16. The method of claim 15, wherein the acid solution comprises from about 64 to 96% formic acid (supplied as a 15% aqueous solution) and 4 to 36% methanol; the acid solution is used in an amount about 50 to 75% the volume of the container; the activated carbon is used in an amount ranging from about 20 to 35 grams per 100 ml solution; the activated carbon has a surface area ranging from about 500 m²/g to about 1750 m²/g; the mechanical dissolution aid is a plurality of pebbles.

17. The method of claim 16, wherein the acid solution comprises about 80% formic acid (supplied as a 15% aqueous solution) and 20% methanol.

18. The method of claim 16, wherein the activated carbon is used in an amount of about 25 grams per 100 ml acid solution.

19. The method of claim 16, wherein the pebbles are approximately 0.2-0.7 cm in diameter and irregularly shaped.

20. The method of claim 16, wherein the pebbles are added in an amount from about one to four times the amount of the activated carbon used.
